(19) United States
(12) Patent Application Publication
(10) Pub. No.: US 2024/0253396 A1
(43) Pub. Date: Aug. 1, 2024

(54) TIRE HAVING OPTIMIZED PERFORMANCE IN TERMS OF ROLLING RESISTANCE AND ROADHOLDING

(71) Applicant: COMPAGNIE GENERALE DES ETABLISSEMENTS MICHELIN, Clermont-ferrand (FR)

(72) Inventors: SOPHIE GANDER, Clermont-Ferrand (FR); GAEL ROTY, Clermont-Ferrand (FR)

(21) Appl. No.: 18/289,621

(22) PCT Filed: Apr. 4, 2022
(86) PCT No.: PCT/FR2022/050624

§ 371 Date: Nov. 6, 2023

(30) Foreign Application Priority Data
May 7, 2021 (FR) FR2104827

(51) Int. Cl. B60C 1/00; B60C 13/00; B60C 15/06

(52) U.S. Cl. CPC B60C 1/0025; B60C 2013/006; B60C 2015/061

(57) ABSTRACT

The invention relates to a tyre (1) for a passenger vehicle of which the performance in terms of rolling resistance has been improved without adversely affecting the transverse slip stiffness. The bead (50) is made more flexible by the use of low-hysteresis materials. The transverse slip stiffness is compensated for through the use of a rigid, low-hysteresis sidewall layer (30). The layers of compounds of the lower region having a viscoelastic loss Tan(δ)max less than or equal to 0.10 represent a volume of between 30% and 90% of the total volume of said lower region, and the elastic shear modulus G′ (M3) of each sidewall layer is in the range [0.5; 10] MPa.

### FIELD OF THE INVENTION

The present invention relates to a tyre for a motor vehicle the performance in terms of rolling resistance of which is improved without adversely affecting the transverse slip stiffness. The invention is more particularly suited to a radial tyre intended to be fitted to a passenger vehicle or a van.

### Definitions

By convention, consideration is given to a frame of reference (O, OX, OY, OZ), the centre O of which coincides with the centre of the tyre, and the circumferential direction OX, axial direction OY and radial direction OZ refer to a direction tangential to the tread surface of the tyre in the direction of rotation, a direction parallel to the axis of rotation of the tyre, and a direction orthogonal to the axis of rotation of the tyre, respectively.

Radially inner/inside and radially outer/outside mean closer to and further away from the axis of rotation of the tyre, respectively.

Axially inner/inside and axially outer/outside mean closer to and further away from the equatorial plane of the tyre, respectively, the equatorial plane of the tyre being the plane passing through the middle of the tread of the tyre and perpendicular to the axis of rotation of the tyre.

The make-up of the tyre is usually described by a representation of its constituent components in a meridian plane, that is, a plane containing the axis of rotation of the tyre.

A tyre comprises a crown intended to come into contact with the ground by means of a tread, the two axial ends of which are connected by means of two sidewalls to two beads that provide the mechanical connection between the tyre and the rim on which it is intended to be mounted.

A radial tyre further comprises a strengthening reinforcement consisting of a crown reinforcement radially inside the tread, and a carcass reinforcement radially inside the crown reinforcement.

The crown reinforcement of a radial tyre comprises a superposition of crown layers extending circumferentially, radially outside the carcass reinforcement. Each crown layer consists of reinforcers that are parallel to one another and coated in a polymer material of the elastomer or elastomer compound type. The assembly consisting of the crown reinforcement and the tread is referred to as the crown.

The carcass reinforcement of a radial tyre usually comprises at least one carcass layer consisting of metal or textile reinforcing elements coated in an elastomer coating compound. The reinforcing elements are substantially parallel to one another and form an angle of between 85° and 95° with the circumferential direction. The carcass layer comprises a main part connecting the two beads to one another and wrapped, in each bead, around an annular reinforcing structure. The annular reinforcing structure can be a bead wire that comprises a circumferential reinforcing element, usually made from metal, surrounded, non-exhaustively, by at least one elastomer or textile material. The carcass layer is wrapped around the annular structure from the inside towards the outside of the tyre to form a turn-up comprising an end. The turn-up, in each bead, allows the carcass reinforcement layer to be anchored to the annular structure of the bead.

Each bead comprises a filler layer extending the annular reinforcing structure radially outwards. The filler layer consists of at least one elastomer filler compound. The filler layer axially separates the main part and the turn-up of the carcass reinforcement.

Each bead also comprises a protective layer extending the sidewall radially inwards and which is axially outside the turn-up. The protective layer is also at least partially in contact, via its axially outer face, with a flange of the rim. The protective layer consists of at least one protective elastomer compound.

Lastly, each bead can comprise a lateral reinforcing layer positioned between the sidewall and the turn-up of the carcass reinforcement. The outer lateral reinforcing layer consists of at least one elastomer compound.

Each tyre sidewall comprises at least one sidewall layer consisting of an elastomer compound and extending axially towards the inside of the tyre from an outer face of the tyre, in contact with the atmospheric air.

Elastomer compound is given to mean an elastomer material obtained by blending its various constituents. An elastomer compound conventionally comprises an elastomer matrix with at least one diene elastomer of the natural or synthetic rubber type, at least one reinforcing filler of the carbon black type and/or of the silica type, a crosslinking system that is usually sulphur-based, and protective agents. For some applications, the elastomers in question can also comprise thermoplastics (TPE).

The expression “composition based on/-based composition” should be understood to mean a composition including the mixture and/or the reaction product of the various constituents used, some of these base constituents being capable of reacting, or intended to react, with one another, at least partially, during the various phases of manufacture of the composition, in particular during its crosslinking or vulcanization.

The expression “parts by weight per hundred parts by weight of elastomer” (or phr) should be understood to mean, within the meaning of the present invention, the proportion by weight per hundred parts of elastomer present in the compound composition under consideration.

An elastomer compound can be mechanically characterized, in particular after curing, by its dynamic properties, such as a dynamic shear modulus G*=(G′2+G″2)1/2, where G′ is the elastic shear modulus and G″ is the viscous shear modulus, and a dynamic loss Tan δ=G″/G′. The dynamic shear modulus G* and the dynamic loss Tan δ are measured on a Metravib VA4000 viscosity analyser in accordance with ASTM D 5992-96. The response of a sample of vulcanized elastomer compound in the form of a cylindrical test specimen with a thickness of 2 mm and a cross-section of 78 mm², subjected to a simple alternating sinusoidal shear stress, at a frequency of 10 Hz and at a temperature of 100° C., is recorded. A strain amplitude sweep is carried out from 0.1% to 50% (outward cycle) and then from 50% to 0.1% (return cycle). For the outward cycle, the maximum value of tan(δ) observed, denoted Tan(δ)ₘₐₓ, is indicated.

The “handling” performance corresponds to the responses of a vehicle/tyre assembly to multiple stresses caused by the driver (steering, acceleration, braking, etc.). Handling is essential both in terms of safety, for the stability of the vehicle, and in terms of driving pleasure.

The tyre plays a key role in handling since it ensures, at the end of the chain, the transmission of forces between the vehicle and the ground in order to maintain the trajectory defined by the driver.

During cornering, in order for the vehicle to stay on a trajectory, it is necessary to generate a force which is equivalent (but in the opposite direction) to the centrifugal force, which tends to move the vehicle away from the trajectory. This lateral force must be generated by the 4 tyres of the vehicle to overcome the centrifugal force.

The deformation of the blocks of rubber in contact with the ground generates a lateral force. The mechanism allowing the tyre to deform the blocks of rubber during cornering is slip. Slip is the angle between the direction of the wheel and the trajectory followed by the vehicle. During cornering, this angle is not zero in order to allow the tyre to deform the blocks of rubber of the tread and thus generate the required lateral forces.

Transverse slip stiffness refers to the variation in the transverse forces generated in the contact patch of the moving tyre compressed by the load carried, as a function of the slip angle applied to the tyre. The transverse slip stiffness is expressed in newtons per degree (N/°).

For small slip angles, that is, angles less than 10°, the transverse force, which is in a direction parallel to the axis of rotation of the tyre, is proportional to the slip angle. The transverse slip stiffness is equal to this coefficient of proportionality.

Transverse slip stiffness is an essential physical variable that links the tyre to the vehicle and determines the quality of the handling of the vehicle on the road.

Rolling resistance is another performance criterion dealt with in the application. Rolling resistance is one of the forces opposing the forward travel of the vehicle. The coefficient of rolling resistance of a tyre (C_{RR}) is the rolling resistance force relative to the load carried by the tyre. The coefficient is expressed in kg/t.

The rolling resistance is essentially linked to the deformation of the tyre. By way of illustration, the beads associated with the sidewalls represent 20% to 30% of the rolling resistance of the tyre, whereas the tread contributes 60% to 80%.

Most often in the present patent application, the tyre is shown mounted on a rim. Said rim is selected in accordance with the specifications of the ETRTO (European Tyre and Rim Technical Organisation) standard, which associates recommended rims with a given tyre size. In general, multiple rim widths can be suitable for one and the same tyre size. The part of the rim that interacts with the tyre within the scope of the invention is axisymmetric relative to the axis of rotation of the tyre. To describe the rim, it is sufficient to describe the generator profile in a meridian plane.

In a meridian plane, the rim comprises at least one flange located at one axial end and connected to a seat that is intended to receive the radially innermost face of the bead. A rectilinear portion that connects the rim flange to the seat via fillets is located between the seat and the flange. The flange of the rim extended by the rectilinear portion axially limits the movement of the beads during inflation.

The mountability of the beads on a rim during inflation is also a performance criterion on which the invention can have an impact. The performance in terms of mountability of the beads consists of evaluating the ability of the beads of a tyre to be installed correctly on a rim during inflation. On the radially innermost face of the bead, there must be sufficient contact with the seat to avoid any leakage of the air used to inflate the tyre. In general, a contact pressure of at least 1.4 MPa is required in this contact area. The inflation pressure traps the bead against the flange of the rim. Again, the contact pressure on the flange must be sufficient to avoid the tyre coming off the rim, in particular during tight cornering at high speed. Means, in particular radiographic means, for observing the beads mounted on a rim make it possible to diagnose the quality of the mounting.

It is therefore possible to rank two tyres with respect to their mountability performance on a rim.

### PRIOR ART

Reducing the emissions of greenhouse gases from transport is one of the major challenges facing vehicle manufacturers today. A great deal of progress has been made through tyres by lowering the rolling resistance, because this has a direct impact on the fuel consumption of the vehicle. By way of illustration, a 20% reduction in the rolling resistance of a tyre makes it possible to save approximately 3% of fuel per 100 km over a combined cycle.

There is still a need to reduce the rolling resistance of tyres for passenger vehicles without adversely affecting their handling on the vehicle.

It has already been proposed to improve the rolling resistance of tyres for passenger vehicles by optimizing their beads. WO 2010/072736 in particular discloses the use of elastomer compositions with low elastic shear moduli G′ of around 15 MPa and viscous shear moduli G″ that are more than 20% lower than the elastic shear moduli in order to obtain a significant reduction in rolling resistance.

It also recommends reducing the rolling resistance even further by optimizing the geometry of the layers of elastomer compound the elastic and viscous moduli of which satisfy the above relationship. This optimization leads to profiles of layers of elastomer compounds that are shorter and wider than in conventional tyres. In some cases, the difficulty of industrial processing in order to manufacture these compound layer profiles is a major drawback of this approach.

FR2994127 describes an improvement to WO 2010/072736 by proposing the addition of a strengthening reinforcement in the beads. The strengthening reinforcement is formed by reinforcers coated in an elastomer compound.

The major drawback of this solution is a significant increase in the industrial manufacturing cost with the introduction of new semi-finished products into the tyre manufacturing process.

The inventors have set themselves the objective of producing a tyre that improves the rolling resistance without adversely affecting the handling of the vehicle, while still controlling the related manufacturing costs.

### DISCLOSURE OF THE INVENTION

This aim has been achieved by a tyre for a passenger vehicle, comprising in a meridian plane:
two beads intended to be mounted on a rim, two sidewall layers connected to the beads, and a crown comprising a tread, the crown having a first side connected to the radially outer end of one of the two sidewall layers and a second side connected to the radially outer end of the other of the two sidewall layers;
at least one carcass reinforcement extending from the two beads to the crown, the carcass reinforcement comprising a plurality of carcass reinforcing elements and being anchored in the two beads by a turn-up around an annular reinforcing structure, so as to form a main part and a turn-up in each bead;
two lower regions being portions of the tyre positioned on either side of the radial axis OZ, a first lower region on a first side of the radial axis OZ including the bead and at least part of the sidewall layer of this first side and a second lower region on the other side of the radial axis OZ including the bead and at least part of the sidewall layer of this second side;
each lower region having a meridian surface delimited by an axial straight line AA′ passing at a radial distance equal to 70% of the distance H, where H is the radial distance between a first axial straight line HH′ passing through the radially innermost point of the annular reinforcing structure, and a second axial straight line DD′ tangent to the tread at its radially outermost point, and radially inwardly said meridian surface being delimited by the peripheral contour of the bead intended to be in contact with the rim;
each lower region occupying a volume obtained by the rotation of said meridian surface about the axis of rotation of the tyre;
the bead of each lower region comprising at least one filler layer contained at least partially between the main part of the carcass reinforcement, the turn-up of the carcass reinforcement and the radially outer portion of the annular reinforcing structure;
the elastomer compounds having an elastic shear modulus and a viscoelastic loss measured in accordance with ASTM D 5992-96, at 23° C., under a shear strain of 10%;
said layers of compounds in each lower region having a viscoelastic loss Tan(δ)max less than or equal to 0.10 represent a volume of between 30% and 90% of the total volume of said lower region;
the elastic shear modulus of each sidewall layer is in the range [0.5; 10] MPa.

The tyres of the invention have two lower regions positioned on either side of the radial axis (OZ). The contour of each lower region in a meridian plane comprises the axial straight line AA′ and the axially outer wall in contact with the ambient air of part of the sidewall layer that is extended radially inwardly by the outer periphery of the protective layer intended to be in contact with the rim. The contour of each lower region continues with the axially inner wall of the bead in contact with the inflation gas of the tyre. In other words, the contour of the lower region follows the outer contours of at least part of the sidewall layer and the outer contour of the bead, both contained in the lower region.

The volume of a lower region is the circumferential extension of its contour in a meridian plane defined above.

Defined in this way, the lower regions represent 20% to 30% of the rolling resistance of the tyre. This contribution is mainly due to the viscoelastic dissipation of the elastomer compounds having larger volumes and higher hysteresis.

When an inflated tyre mounted on the rim and compressed by the load carried is rolling, the lower regions undergo high amplitude bending strain cycles resulting from periodically passing through the contact patch. These strains, associated with the hysteresis levels of the elastomer compounds, result in the viscoelastic dissipation of the lower regions.

The principle of the invention is to provide the elastomer compound layers of the lower region with the largest volume with hysteresis measured by a value of Tan(δ)max less than or equal to 0.10 so as to reduce the viscoelastic dissipation of the bead and therefore improve the rolling resistance compared with a tyre of usual design. The usual design of the beads uses an elastic shear modulus greater than 30 MPa for said elastomer compound layers. Most often, however, such elastomer compounds also have hysteresis measured by a value of Tan(δ)max significantly greater than 0.10.

In the lower regions of the tyres of the invention, between 30% and 90% of the volume of each lower region consists of low-hysteresis elastomer compounds, that is, compounds with hysteresis measured by a value of Tan(δ)max less than 0.10.

By allocating an elastomer compound provided with an elastic shear modulus that can be up to 10 MPa to the sidewall layer of a tyre of the invention, the lateral slip stiffness is kept at an appropriate level, useful for good handling of the vehicle. The usual design of the sidewalls aims for an elastic shear modulus less than or equal to 1.5 MPa.

The combination of the selection of low-hysteresis elastomer compounds for the largest volumes of the lower region and the selection of a sidewall layer provided with an elastic shear modulus that can be up to 10 MPa are the main features that result in the tyre of the invention, which provides a compromise between improving the rolling resistance and having an adverse effect on handling. The stiffer sidewall layer of the tyres of the invention compared to the usual design compensates, for example, for the reduction in the elastic shear modulus of the filler layer. In addition, the solutions implemented do not require any major changes in processes, which makes it possible to keep the industrial manufacturing cost at a normal level.

Advantageously, the elastic shear modulus of the sidewall layer is preferably in the range [1.5; 10] MPa, and more preferably in the range [2.5; 10] MPa.

The beads of the tyres of the invention rely in particular on a balance between the shear stiffness and the hysteresis of the elastomer compounds forming it. The elastic shear modulus of each sidewall layer remains less than 10 MPa so that the hysteresis remains at a level measured by a value of Tan(S)max less than or equal to 0.10. The invention works on the basis of an elastic shear modulus of the sidewall layer greater than or equal to 0.5 MPa.

Preferably, said layers of compounds in the lower region having a viscoelastic loss Tan(δ)max less than or equal to 0.10 represent a volume of between 40% and 90% of the total volume of said lower region, and more preferably a volume of between 50% and 90% of the total volume of the lower region.

The architecture of the lower regions varies depending on the presence of the elastomer compound layers necessary for the correct operation of the tyre. In particular, the diameter of the mounting rim is a parameter that has a significant impact on the architecture of the beads. By way of illustration, for rim diameters above 16 inches, each bead often comprises a lateral layer for reinforcing the filler layer in order to transmit the torque from the vehicle efficiently. The volume of low-hysteresis compounds relative to the total volume of the lower region is affected by this. A content of 90% of the volume of low-hysteresis elastomer compounds is an upper limit that means that each lower region also comprises non-hysteretic materials. Conversely, for smaller rim diameters, the architecture of the lower regions can be simplified, and the content of low-hysteresis compounds relative to the total volume of each lower region can reach a value of 40%.

Advantageously, the filler layer consists of an elastomer compound the viscoelastic loss Tan(δ)max of which is less than or equal to 0.10.

The filler layer of the bead generally occupies a large volume and undergoes significant shear strains due to the variations in tension in the reinforcers of the main part of the carcass layer and the turn-up thereof. Selecting a low-hysteresis elastomer compound helps to control the level of viscoelastic dissipation.

According to one particularly advantageous embodiment, the bead comprises a lateral reinforcing layer consisting of an elastomer compound occupying a volume contained at least partially between the sidewall layer and the turn-up of the carcass reinforcement.

According to the inventors, the lateral reinforcing layer of the bead provides additional transverse stiffness to that provided by the first filler layer. Depending on these material properties in terms of Tan(δ)max and dynamic shear stiffness, said reinforcer makes it possible to regulate the balance in terms of performance between rolling resistance and handling.

Advantageously, in one variant of this embodiment, said lateral reinforcing layer of at least one bead consists of an elastomer compound with a viscoelastic loss Tan(δ)max less than or equal to 0.10.

In this variant of the embodiment, the two layers of compounds, namely the filler layer and the lateral reinforcing layer, satisfy the property of having a viscoelastic loss Tan(δ)max less than 0.10. The increase in rolling resistance is optimum, while the handling of the tyre mounted on a vehicle remains as expected.

In another embodiment of the invention, a rim contact curve in each bead comprises the points of the tyre in contact with the rim. Said rim contact curve connects a first point M1 of the tyre that is positioned axially outermost, and in contact with the rim, and a second point M2 of the tyre that is also in contact with the rim and is located in the middle of the rectilinear portion connecting the flange to the seat of the rim. The length of said rim contact curve is the curvilinear distance from point M1 to point M2 along the contact curve. Said tyre also comprises two sections in a vertical meridian plane of the inflated tyre mounted on a rim and compressed against the ground by a vertical load, wherein the load and the inflation pressure are determined in accordance with a specification such as the ETRTO (European Tyre and Rim Technical Organisation) standard, a first section being located in the contact patch, and a second section being located on the opposite side from the preceding section relative to the axis of rotation of the tyre. The length of the rim contact curve, LADC, is measured in the first section located in the contact patch, in at least a first bead. The length of the rim contact curve, LCJ, is measured in the second section located opposite the contact patch relative to the axis of rotation of the tyre, in at least a second bead, and the ratio of the difference in the lengths of the rim contact curves in the two sections, i.e. 100*(LADC−LCJ)/LCJ, is greater than or equal to 30%.

In this embodiment, the rate of variation in rim contact of the tyres of the invention is significantly greater than that found on the tyres of the prior art.

When the inflated tyre, mounted on a rim, is compressed by a load that is carried, the points on the tyre that are in contact with the rim can vary from one meridian to the other. It follows that the length of the rim contact curve as defined above also varies from one meridian to the other.

The tyre is designed such that the rim contact curve is as long as possible in the contact patch, by comparison with the tyres of the prior art, and more specifically in the meridian at the centre of the contact patch. In these conditions, the inventors believe that the contribution of the rim contact to the slip stiffness is at its greatest.

In a meridian plane of an inflated tyre mounted on a rim and compressed by the load carried, a first section of the tyre can be seen that passes through the centre of the contact patch. Contact patch is given to mean all of the points on the tyre that, at a given moment, are in contact with the ground against which the tyre is compressed. The point of the contact patch located on the vertical axis OZ is referred to as the centre of the contact patch. Another section of the tyre that generally defines a deformed state that can be likened to the state of axisymmetric inflation can also be seen opposite the contact patch relative to the axis of rotation OY of the tyre.

The rate of variation in the rim contact corresponds to the maximum value of the change in the rim contact lengths per wheel revolution.

According to the inventors, an essential step in designing a tyre in this embodiment consists of modifying its outer profile in the area of contact with the rim. Various solutions are possible, for example increasing the axial thickness of the sidewall layer at the join with the protective layer. Other solutions consist of modifying the outer profile so as to obtain a profile in the contact area having the same curvature as the rim flange. Yet another solution consists of inserting a cushion of compound in the area at the join between the sidewall layer and protective layer, at the flange of the rim. This cushion of compound can preferably consist of the same compound as the sidewall layer, so as to retain the industrial manufacturing cost. The main requirement of this cushion of elastomer compound is its elastic shear modulus, which advantageously could be for example the same as the sidewall layer.

Advantageously, the ratio of the difference in the lengths of the rim contact curves of the two sections, i.e. 100*(LADC−LCJ)/LCJ, is greater than or equal to 40%, preferably greater than or equal to 50%, more preferably greater than or equal to 60%.

The outer profile in the area of contact with the rim can be modified to achieve a specific rim contact variation rate. It is therefore a tool for adjusting the transverse slip stiffness when seeking a performance compromise between the rolling resistance and the handling of the tyre. The transverse slip stiffness is an increasing function of the rim contact variation rate. For rim contact variation rates greater than or equal to 60%, the modification of the outer profile of the sidewall layer makes it easier to mount the bead, but excessive rates greater than 100% could inhibit the mountability.

In addition to the main features of the invention, the inventors have identified tools linked to the geometry of the layers of compounds of the bead for further optimizing the compromise in terms of performance of the tyre with improved rolling resistance while retaining good handling.

Advantageously, the distance DRB being the radial distance from a radially outer end of the filler layer, said distance DRB is less than or equal to 50% of the radial height H of the tyre.

The height H of the tyre is the normal distance between a first straight line HH′ parallel to the axis of rotation of the tyre and tangent to the radially innermost point of the annular reinforcing structure, and a second straight line DD′ also parallel to the axis of rotation of the tyre and passing through the radially outermost point of the tread. The radial height H is measured on the tyre mounted on a rim and inflated to a reference pressure in accordance with the ETRTO (European Tyre and Rim Technical Organisation) specifications.

Advantageously, the distance DRI being the radial distance from a radially inner end of the lateral reinforcing layer to the straight line HH′, said radial distance DRI is in the range [5%; 25%] of the radial height H of the tyre.

More advantageously, the distance DRL being the radial distance from the radially outer end of the lateral reinforcing layer and the straight line HH′, said distance DRL is greater than or equal to 25% of the radial height H of the tyre.

The lateral reinforcing layer contained between the sidewall and the turn-up of the carcass reinforcement contributes to the stiffness of the bead in addition to the first filler layer. According to the inventors, its positioning is regulated by the dimensions DRI and DRL so as to withstand the bending stresses and extension-compression stresses of the bead when it enters the contact patch.

In one advantageous embodiment of the invention, the turn-up of the carcass reinforcement is pressed against the main part of the carcass reinforcement over its entire radially outer height.

As mentioned above, the carcass reinforcement is formed of reinforcers encased between two layers of elastomer compounds. “The turn-up of the carcass reinforcement is pressed against the main part of the carcass reinforcement” means that the turn-up is in contact with the main arm of the carcass reinforcement. The contact is made on a surface positioned between the two coating layers of the carcass reinforcement.

In this configuration, the volume of the first filler layer is limited to a strict minimum around the annular reinforcing structure. This configuration is very advantageous for reducing the rolling resistance of the bead.

In another embodiment, the tyre comprises a reinforcement for strengthening the bead axially outside the carcass reinforcement and axially inside the sidewall.

The strengthening reinforcement of the bead is formed of reinforcers parallel to one another and encased between two layers of elastomer compounds. The addition of this semi-finished product generates an additional manufacturing cost that must be compensated for. In order to limit the impact on the manufacturing cost of such a solution, this embodiment can be combined with pressing the turn-up of the carcass reinforcement against the main part of the carcass reinforcement.

Advantageously, in each bead, the elastomer compound forming at least one layer of the filler layer, and/or the lateral reinforcing layer, and/or the sidewall layer, has a composition based on a diene elastomer, a crosslinking system, and a reinforcing filler such as carbon black 550, at an overall content of between 50 and 75 phr.

Even more advantageously, in each bead, the elastomer compound forming the filler layer, the elastomer compound forming the lateral reinforcing layer, and the elastomer compound forming the sidewall layer, have the same composition.

A “diene” elastomer (or equally rubber) is understood to mean, as is known, an elastomer derived at least in part (i.e. a homopolymer or a copolymer) from diene monomers, that is, monomers bearing two conjugated or unconjugated carbon-carbon double bonds. The diene elastomer used is preferably selected from the group consisting of polybutadienes (BRs), natural rubber (NR), synthetic polyisoprenes (IRs), styrene-butadiene copolymers (SBRs), butadiene-isoprene copolymers (BIRs), styrene-isoprene copolymers (SIRs), styrene-butadiene-isoprene copolymers (SBIRs) and the compositions of these elastomers.

A preferred embodiment consists of using an “isoprene” elastomer, that is, an isoprene homopolymer or copolymer, in other words a diene elastomer selected from the group consisting of natural rubber (NR), synthetic polyisoprenes (IRs), the different isoprene copolymers and the compositions of these elastomers.

The isoprene elastomer is preferably natural rubber or a synthetic polyisoprene of the cis-1,4 type. Of these synthetic polyisoprenes, use is preferably made of polyisoprenes that have a content (mol %) of cis-1,4 bonds greater than 90%, more preferably still greater than 98%. According to other preferred embodiments, the diene elastomer can consist, completely or partially, of another diene elastomer such as, for example, an SBR (E-SBR or S-SBR) elastomer used unblended or blended with another elastomer, for example of the BR type.

The rubber composition can also comprise all or some of the additives usually employed in the rubber matrices intended for the manufacturing of tyres, such as for example reinforcing fillers such as carbon black or inorganic fillers such as silica, coupling agents for inorganic fillers, anti-ageing agents, antioxidants, plasticizers or extender oils, whether the latter are aromatic or non-aromatic in nature (in particular oils that are very slightly aromatic or non-aromatic, for example of the naphthene or paraffin type, with high or preferably low viscosity, MES or TDAE oils, plasticizing resins with a high Tg greater than 30° C.), agents that improve the workability (processability) of the compositions in the uncured state, tackifying resins, a crosslinking system based either on sulphur or on sulphur and/or peroxide donors, accelerators, vulcanization activators or retardants, anti-reversion agents, methylene acceptors and donors such as for example HMT (hexamethylenetetramine) or HMMM (hexamethoxymethylmelamine), reinforcing resins (such as resorcinol or bismaleimide), and known adhesion promoter systems of the metal salt type for example, in particular salts of cobalt or nickel.

### BRIEF DESCRIPTION OF THE DRAWINGS

Further details and advantageous features of the invention will become apparent hereinafter from the description of exemplary embodiments of the invention given with reference to the figures, which depict meridian views of diagrams of a tyre according to one embodiment of the invention. In order to make them easier to understand, the figures are not shown to scale.

FIG. 1 comprises a view 1-A that shows a cross-section of a tyre of the invention in a meridian plane, and a view 1-B that shows an enlargement of a portion of the meridian view 1-A surrounded by a dashed circle showing a lower region of a tyre of the invention.

FIGS. 2-A, 2-B, 2-C and 2-D show an embodiment of the invention with changes to the outer profile of the sidewall layer in order to facilitate contact with the rim.

FIG. 3 shows a meridian cross-section of the inflated tyre, mounted on a rim and compressed by the load carried. A first section in the contact patch can be seen, and a second section opposite the contact patch relative to the axis (OY). This figure illustrates the determination of the rate of variation in contact with the rim.

FIGS. 4-A and 4-B show the main dimensions of the lower region.

### DETAILED DESCRIPTION OF THE INVENTION

The invention was implemented on a passenger vehicle tyre of size 245/45R18 in accordance with the specifications of the ETRTO (European Tyre and Rim Technical Organisation) standard. Such a tyre can carry a load of 800 kilos, inflated to a pressure of 250 kPa.

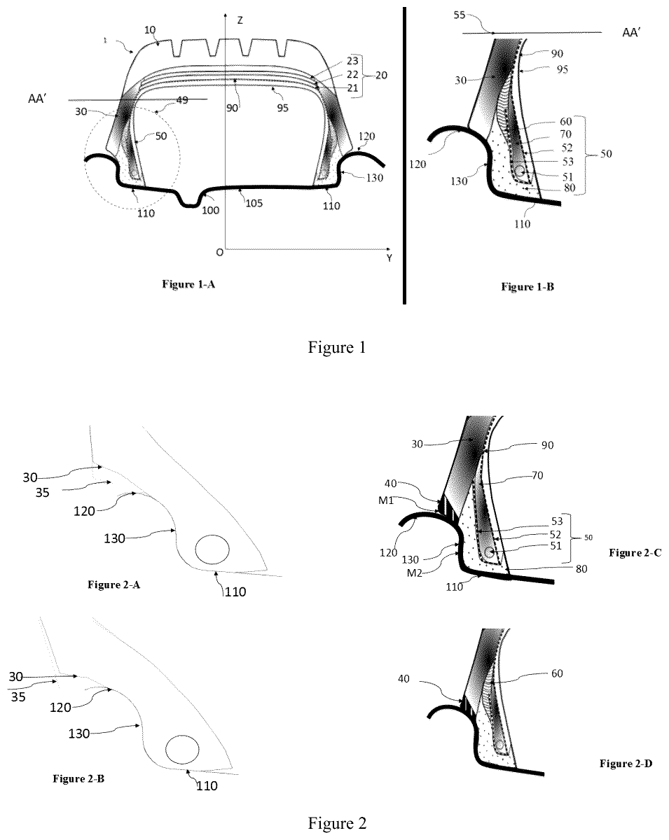

In FIG. 1-A, the tyre with general reference sign 1 comprises a carcass reinforcement 90 consisting of reinforcers coated in a rubber composition, and two beads 50 in contact with a rim 100. A region 49 delimited by a dashed circle defines a lower region of the tyre, an enlargement of which is given in FIG. 1-B. The carcass reinforcement 90 is anchored in each of the beads 50. The tyre further comprises a crown reinforcement 20 comprising two working layers 21, 22 and a hooping layer 23. Each of the working layers 21 and 22 is reinforced by filamentary reinforcing elements that are parallel within each layer and crossed from one layer to the other, forming angles of between 10° and 70° with the circumferential direction. The hooping layer 23 is positioned radially outside the crown reinforcement 20, this hooping layer 23 being formed of reinforcing elements oriented circumferentially and wound in a spiral. A tread 10 is placed radially on the hooping layer 23; it is this tread 10 that provides the contact between the tyre 1 and the ground. The tyre 1 depicted is a “tubeless” tyre: it comprises an “inner liner” 95 made from a rubber composition impermeable to the inflation gas, covering the inner surface of the tyre.

The part of the rim 100 that interacts with the tyre within the scope of the invention is axisymmetric relative to the axis of rotation of the tyre.

In a meridian plane, the rim 100 comprises at least one flange 120 located at one axial end and connected to a seat 110 that is intended to receive the radially innermost face of the bead. A rectilinear portion 130 that connects the rim flange 120 to the seat 110 via fillets is located between the seat 110 and the flange 120. The flange 120 of the rim extended by the rectilinear portion 130 axially limits the movement of the beads during inflation.

FIG. 1-B shows a lower region with general reference sign 55 containing the sidewall layer 30 and the bead 50. The contour of the lower region follows the outer contours of at least part of the sidewall layer 30 and the outer contour of the bead 50.

Said bead 50 partially comprises a carcass reinforcement 90 that comprises a main part 52, and is then wrapped around an annular reinforcing structure 51 to form a turn-up 53. A filler layer 70 is positioned between the main part 52 of the carcass reinforcement 90 and its turn-up 53. Depending on the embodiment, the bead 50 can also comprise a lateral reinforcing layer 60, positioned axially outside the turn-up 53 and axially inside the sidewall layer 30. Axially innermost from the bead 50, an airtight layer 95 forms the inner wall in contact with the internal inflation air.

Said bead 50 also comprises a protective layer 80 that is in axially outer contact with a rectilinear portion 130 of the rim so as to limit the axial movement of the bead. Said protective layer 80 also comprises a portion intended to be in contact with the rim on the rim seat 110. A sidewall layer 30 interacts with the bead 50 and forms an outer lateral wall.

FIG. 2-A depicts the outer profiles of a bead 50 of a tyre according to a particular embodiment of the invention compared with the bead of a tyre of usual design. The bead 50 is depicted in a section opposite the contact patch. The two profiles differ in an area at the rim flange 120. The reference sign 30 indicates the profile of a tyre of the prior art, and the reference sign 35 shows the modification of the profile that is made on the tyre of the invention to facilitate contact with the rim 100.

FIG. 2-B depicts the same thing as FIG. 2-A, but the profiles are shown in the centre of the contact patch in which contact is made with the ground. The tyre is in contact with the entire rim flange 120, unlike in FIG. 2-A. The rate of variation in rim contact reflects this change in the rim contact.

In another embodiment depicted in FIG. 2-C, there is a cushion of elastomer compound 40 (modification located at the radially inner end of the sidewall 30) that is intended to be in contact with the rim flange 120. The cushion of compound 40 is delimited radially on the inside by a curve that closely follows the profile of the rim flange 120. A first side of the cushion of elastomer compound 40 has a suitable geometric shape that anticipates contact with the curvature of the rim flange so as to closely follow the shape of the rim flange 120 when contact is being made, a second side of the cushion of elastomer compound extends an outer side of a sidewall in contact with the ambient air, a third side of the cushion of elastomer compound 40 is in contact with the radially inner end of the sidewall, and lastly a fourth side of the cushion of elastomer compound is in contact with the protective layer 80.

In FIG. 2-C, the rim contact curve extends from a first point M1 of the tyre that is positioned axially outermost, and in contact with the rim, and a second point M2 of the tyre that is also in contact with the rim and is located in the middle of the rectilinear portion connecting the flange 120 to the seat 110 of the rim. The length of this rim contact curve is the curvilinear distance from point M1 to point M2 along the rim contact curve.

FIG. 2-D is a variant of the preceding embodiment characterized by the presence of a lateral reinforcing layer 60 of the bead 50, positioned axially outside the turn-up 53 of the carcass reinforcement 90 and axially inside the sidewall layer 30.

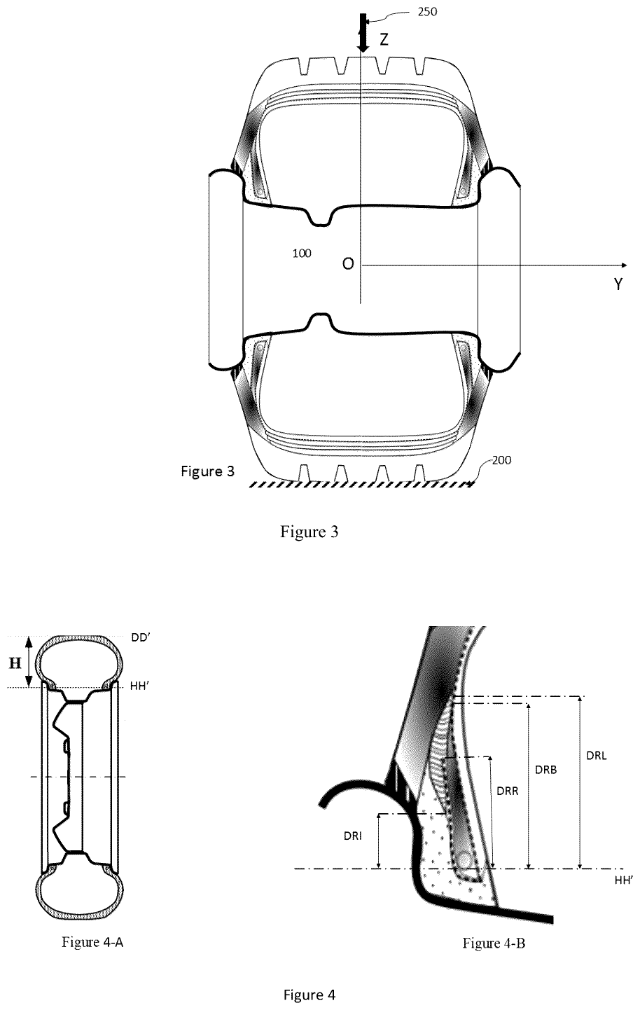

FIG. 3 is a view in the vertical plane of a tyre of the invention according to a previous embodiment. The tyre is inflated, mounted on a rim 100 and compressed by the load carried 250 against the ground 200. A first meridian section in the contact patch can be seen, and a second meridian section opposite the contact patch. The length of the rim 100 contact curve, LADC, is measured in the first section located in the contact patch, in at least a first bead. The length of the rim contact curve, LCJ, is also measured in the second section, in at least a second bead. The ratio of the difference in the lengths of the rim contact curves of the two sections, i.e. 100*(LADC−LCJ)/LCJ, is greater than or equal to 30%, and in this case is equal to 62%.

FIG. 4-A illustrates the determination of the height H. The height H of the tyre is the normal distance between a first straight line HH′ parallel to the axis of rotation of the tyre and tangent to the radially innermost point of the annular reinforcing structure, and a second straight line DD′ also parallel to the axis of rotation of the tyre and passing through the radially outermost point of the tread. The radial height H is measured on the tyre mounted on a rim and inflated to a reference pressure in accordance with the ETRTO (European Tyre and Rim Technical Organisation) specifications.

FIG. 4-B depicts the geometric parameters of the bead relating to the invention. The heights are defined from the straight line HH′, which is tangent to the bead wire 51 at its radially innermost point:
DRI is the radial distance from HH′ of the radially inner end of the lateral reinforcing layer 60. The radial distance DRI is less than or equal to 20% of the radial height H of the tyre, and in the example shown here is 5 mm;
DRL is the radial distance from the straight line HH′ of the radially outer end of the lateral reinforcing layer 60. The radial distance DRL is greater than or equal to 25% of the radial height H of the tyre, and in the example shown here is 38 mm;
DRR is the radial distance from HH′ of the end of the turn-up of the carcass reinforcement 90. The radial distance DRR is greater than or equal to 10% of the radial height H of the tyre, and in the example shown here is 20 mm;
DRB is the radial distance from HH′ of the radially outer end of the filler layer 70, and in the example shown here is 28 mm.

The following Table 1 gives the compositions of elastomer compounds of a lower region of the invention. The main compounds used are listed, for each of which the main ingredients are expressed in phr (parts by weight per hundred parts by weight of elastomer):

TABLE 1

| | Elastomer | Elastomer | Reinforcing | | | | | |
|---|---|---|---|---|---|---|---|---|
| | NR | BR | filler - | | | | | |
| | (Natural | (Butadiene | carbon | | | | Reinforcing | |
| | rubber) | Rubber) | black | Antioxidant | Sulphur | Acceleratol | resin | Hardener |
| M1 | 100 | 0 | 75 (N326) | 1.5 | 8.5 | 0.95 | 12 | 4.18 |
| M2 | 100 | 0 | 75 (N326) | 2 | 7.5 | 0.97 | 12 | 6.8 |
| M3 | 35 | 65 | 30 (N550) | 1.3 | 8.0 | 4.75 | 0 | 0 |
| | | | 10 (Silica) | | | | | |
| M4 | 35 | 65 | 48 (N550) | 5 | 1.4 | 1.4 | 18 | 0 |

The compounds of the invention used in this example are based on a natural rubber elastomer or a blend of natural rubber and butadiene for compounds M3 and M4, reinforced with carbon black. Plasticizers (reinforcing resin) are incorporated into the composition to facilitate the processability of the compounds. The compounds also comprise vulcanization agents, sulphur, an accelerator, and protection agents. The associated mechanical and viscoelastic properties, measured at 23° ° C. under a strain amplitude of 10%, are summarized in Table 2:

TABLE 2

| | G′ | G″ | Tan(δ)max |
|---|---|---|---|
| M1 | 46 | 7 | 0.2 |
| M2 | 48 | 8 | 0.2 |
| M3 | 2.47 | 0.06 | 0.03 |
| M4 | 1.26 | 0.100 | 0.08 |

Configurations of tyres of the invention were tested in order to clearly highlight the performance offered by the invention. The results of these tests were compared with those obtained on control tyres.

The control tyre T1 illustrated in FIGS. 1-A and 1-B corresponds to a tyre comprising a filler layer consisting of elastomer compound M1, a lateral reinforcing layer of the bead consisting of elastomer compound M2, and a sidewall layer consisting of elastomer blend M4. The profile of the sidewall layer is of the usual design, that is, it has not been modified to facilitate contact with the rim.

A second control tyre T2 has the same specifications as T1, but the filler and reinforcing elastomer compounds consist of compound M3.

The first tyre P1 according to the invention has the same specifications as the control tyre T1, but the sidewall layer and the lateral reinforcing layer consist of elastomer compound M3.

The second tyre P2 according to the invention has the same specifications as the control tyre T1, but the filler layer and the sidewall layer consist of elastomer compound M3.

The third tyre P3 according to the invention differs from the control tyre in that the layers of elastomer compounds of the filler, reinforcing and sidewall layers consist of elastomer compound M3.

Lastly, the fourth tyre P4 of the invention differs from P3 in the modification of the profile of the sidewall layer for a rate of variation in rim contact greater than 30%.

The configurations of the tyres P1, P2 and P3 of the invention are illustrated in FIG. 1-B. The illustrations for configuration P4 can be seen in FIGS. 2-A, 2-B and 2-D.

The rate of variation in rim contact is 62% for P4, after partial modification of the profile of the sidewall layer in the area of contact with the rim, as depicted in FIGS. 2-A and 2-B.

For all of the tyres of the invention, the content of elastomer compounds with hysteresis less than or equal to 0.10 is in the range [30%; 90%], as illustrated in Table 3 below:

TABLE 3

| Tyre | Layers of the lower region | % Volume of |
|---|---|---|
| configuration | with compound M3 | lower region |
| P1 | Sidewall layer + reinforcing layer | 44 |
| P2 | Sidewall layer + filler layer | 41 |
| P3 | Sidewall layer + filler layer + | 54 |
| | reinforcing layer | |
| P4 | Sidewall layer + filler layer + | 54 |
| | reinforcing layer + modified rim | |
| | contact area profile | |

The rolling resistance test was carried out in accordance with ISO 28580. For a tested tyre, the result is the coefficient of rolling resistance, which represents the ratio of the resistance force opposing the forward travel of the vehicle owing to hysteresis of the tyres divided by the load carried.

The transverse slip stiffness was measured on dedicated measuring machines, such as those sold by MTS.

A result greater than (respectively less than) 100% indicates an improvement (respectively a deterioration) in the performance criterion under consideration.

The results obtained are summarized in Table 4 below:

TABLE 4

| | Rolling resistance | Transverse slip stiffness |
|---|---|---|
| T1 | 100 | 100 |
| T2 | 110 | 96 |
| P1 | 108 | 98 |
| P2 | 104 | 100 |
| P3 | 112 | 99 |
| P4 | 111 | 102 |

All of the tyres of the invention achieve the compromise sought between rolling resistance and handling controlled by the transverse slip stiffness. Tyres P1 and P3 have a transverse slip stiffness of 98% and 99% respectively, without noticeably affecting the handling of the vehicle. Tyres P2 and P4 have superior or equal performance to the target sought.

All of the variants of tyres according to the invention disclosed are produced without changing the processes and retain a normal industrial manufacturing cost.

In addition, the invention can be applied more generally to other bead architectures from those described here, such as for example a bead having a first filler layer and a second lateral reinforcing layer, even if the carcass reinforcement does not comprise a turn-up.

1.-15. (canceled)

16. A tire (1), for a passenger vehicle, comprising in a meridian plane:
two beads (50) intended to be mounted on a rim;
two sidewall layers (30) connected to the beads (50);
a crown (20) comprising a tread (10), the crown (20) having a first side connected to a radially outer end of one of the two sidewall layers (30) and a second side connected to a radially outer end of the other of the two sidewall layers (30);
at least one carcass reinforcement (90) extending from the two beads (50) to the crown (20), the at least one carcass reinforcement (90) comprising a plurality of carcass reinforcing elements and being anchored in the two beads (50) by a turn-up around an annular reinforcing structure (51), so as to form a main part (52) and a turn-up (53) in each bead;
two lower regions (55) being portions of the tire, positioned on either side of a radial axis (OZ) passing through a center O of the tire, a first lower region on a first side of the radial axis (OZ) including the bead (50) and at least part of the sidewall layer (30) of the first side and a second lower region on an other side of the radial axis (OZ) including the bead and at least part of the sidewall layer of the second side,
where each lower region (55) has a meridian surface delimited by an axial straight line (AA′) passing at a radial distance equal to 70% of the distance H, where H is a radial distance between a first axial straight line (HH′) passing through a radially innermost point of the annular reinforcing structure (51), and a second axial straight line (DD′) tangent to the tread at its radially outermost point, and radially inwardly the meridian surface being delimited by a peripheral contour of the bead intended to be in contact with the rim,
where each lower region occupying a volume obtained by rotation of the meridian surface about an axis of rotation of the tire,
where the bead (50) of each lower region (55) comprises at least one filler layer (70) contained at least partially between the main part of the carcass reinforcement (52), the turn-up of the carcass reinforcement (53) and the radially outer portion of the annular reinforcing structure (51), and
where each elastomer compound of the tire has an elastic shear modulus and a viscoelastic loss measured in accordance with ASTM D 5992-96, at 23° C., under a shear strain of 10%,
wherein each layer of compound of each lower region (55) having a viscoelastic loss Tan(δ)max less than or equal to 0.10 represents a volume of between 30% and 90% of a total volume of the lower region, and
wherein an elastic shear modulus of each sidewall layer is in a range [0.5; 10] MPa.

17. The tire (1) according to claim 16, wherein the elastic shear modulus of the sidewall layer is in the range [1.5; 10] MPa.

18. The tire (1) according to claim 16, wherein layers of compounds of the lower region having a viscoelastic loss Tan(δ)max less than or equal to 0.10 represent a volume of between 40% and 90% of a total volume of the lower region.

19. The tire (1) according to claim 16, wherein the at least one filler layer consists of an elastomer compound with a viscoelastic loss Tan(δ)max less than or equal to 0.10.

20. The tire (1) according to claim 16, wherein the bead comprises a lateral reinforcing layer (60) consisting of an elastomer compound occupying a volume contained at least partially between the sidewall layer (30) and the turn-up (53) of the carcass reinforcement.

21. The tire (1) according to claim 20, wherein the lateral reinforcing layer (60) of the bead consists of an elastomer compound with a viscoelastic loss Tan(δ)max less than or equal to 0.10.

22. The tire (1) according to claim 16, wherein a rim contact curve in each bead (50) comprises points of the tire (1) in contact with the rim (100), the rim contact curve connecting a first point M1 of the tire that is positioned axially outermost, and in contact with the rim, and a second point M2 of the tire that is also in contact with the rim and is located in a middle of a rectilinear portion (130) connecting a flange (120) to a seat (110) of the rim,
wherein the tire (1) also comprises two sections in a vertical meridian plane of the inflated tire, mounted on a rim, and compressed against a ground by a vertical load (250), wherein the vertical load and inflation pressure are determined in accordance with an ETRTO standard, a first section being located in the contact patch, and a second section being located on an opposite side from the preceding section relative to the axis of rotation of the tire,
wherein a length of the rim contact curve, LADC, is measured in the first section located in the contact patch, in at least a first bead,
wherein a length of the rim contact curve, LCJ, is measured in the second section located opposite the contact patch relative to the axis of rotation of the tire, in at least a second bead, and
wherein a ratio of a difference in the lengths of the rim contact curves in the two sections, 100*(LADC−LCJ)/LCJ, is greater than or equal to 30%.

23. The tire (1) according to claim 22, wherein the ratio of the difference in the lengths of the rim contact curves of the two sections is greater than or equal to 40%.

24. The tire (1) according to claim 16, wherein a distance DRB, which is a radial distance from a radially outer end of the filler layer (70), is less than or equal to 50% of the radial height H of the tire (1).

25. The tire (1) according to claim 20, a distance DRI being the radial distance from a radially inner end of the lateral reinforcing layer (60) to the straight line (HH′), wherein the radial distance DRI is in a range [5%; 20%] of the radial height H of the tire (1).

26. The tire (1) according to claim 20, a distance DRL being the radial distance from the radially outer end of the lateral reinforcing layer (60) to the straight line (HH′), wherein the radial distance DRL is greater than or equal to 25% of the radial height H of the tire (1).

27. The tire (1) according to claim 16, wherein the turn-up (53) of the carcass reinforcement (90) is in radially outer contact with the main part (52) of the carcass reinforcement (90) along the turn-up (53).

28. The tire (1) according to claim 16, further comprising a reinforcement for strengthening the bead (50) axially outside the turn-up (53) of the carcass reinforcement (90) and axially inside the sidewall (30).

29. The tire (1) according to claim 20, wherein, in each bead, an elastomer compound forming at least one layer of the filler layer (70), and/or the lateral reinforcing layer (60), and/or the sidewall layer (30), has a composition based on a diene elastomer, a crosslinking system, and a reinforcing filler at an overall content of between 50 and 75 phr.

30. The tire (1) according to claim 29, wherein, in each bead, the elastomer compound forming the filler layer (70), the elastomer compound forming the lateral reinforcing layer (60) and the elastomer compound forming the sidewall layer (30) have the same composition.
